(19) United States
(12) Patent Application Publication
(10) Pub. No.: US 2010/0102264 A1
(43) Pub. Date: Apr. 29, 2010

(54) SHEAR VALVE APPARATUS AND METHODS TO IMPROVE LEAKAGE AND WEAR

(75) Inventors: Charles Bickoff, Sharon, MA (US); Thomas H. Peterson, Wilmington, MA (US)

Correspondence Address: MESMER & DELEAULT, PLLC, 41 BROOK STREET, MANCHESTER, NH, 03104, US

(73) Assignee: Nova Biomedical Corporation, Waltham, MA (US)

(21) Appl. No.: 12/258,475

(22) Filed: Oct. 27, 2008

(51) Int. Cl. F16K 3/36; F16K 11/16

(52) U.S. Cl. 251/355; 137/625.18; 137/625.21; 251/314

(57) ABSTRACT

A shear valve assembly includes a stationary valve manifold having a manifold planar surface containing a plurality of manifold input ports and one or more manifold output ports, a movable valve switch having a switch planar surface in slidable, interactive contact with the manifold planar surface forming an interactive contact junction, the switch planar surface having a fluid switching channel capable of connecting one of the plurality of manifold input ports with one of the one or more manifold output ports, a surface modifying component disposed at the interactive contact junction that provides a period of extended useful life of the manifold planar surface and the switch planar surface beyond the useful life of pre-lubricated interactive contact junction, a drive shaft connected to the valve switch, and a valve housing supporting the stationary valve manifold, the movable valve switch, and the drive shaft.

### BACKGROUND OF THE INVENTION

1. Field of the Invention

The present invention relates generally to shear valves. Particularly, the present invention relates to shear valves having improved wear and sealability of the interface between the rotating/sliding and stationary components and reducing the forces to drive the rotating or sliding component.

2. Description of the Prior Art

Many devices and processes require fluid switching valves for functions such as fluid selection, fraction collection, fluid redirection, stream sampling, sample injection, and the like. A common valve used in these applications is the multiport selector valve. Multiport selector valves have been known for some time and include rotary valves and linear shear valves. Rotary and linear shear valves have a very flat, rotating or linear element that moves against a similarly flat stationary member. The rotary or linear element commonly has channels used to direct the flow of fluids such as liquids and gases between various inlet and outlet ports. Sealing the interface surfaces between the rotating or linear element and the stationary element is accomplished by reliance on the flatness of the interface surfaces or by compliance of the interface surfaces through the selection of materials such as plastics or elastomers.

Some of the desirable features in rotary and linear shear valves are low friction and long lifetime. Valves with a short lifetime require frequent maintenance to replace one or more of the sealing parts. With high duty cycles, maintenance may be required every week. The downtime caused by such maintenance is undesirable as it becomes a significant expense and slows productivity.

Lifetime is defined as the number of actuations of the rotary or linear shear valve before sealing parts need to be replaced due to excessive leakage. Leakage can be from one or all of the ports or grooves radially outward to the extra-valve environment, i.e. to ambient, or leakage can be between ports. The latter is often the more detrimental to function because of cross-contamination.

It is common to use a stationary element of metal such as stainless steel, so tubing connections can be attached in the outlet openings, and to use a rotary element of fluorocarbon-containing plastic for low friction sliding against the metal under a clamping force that presses the surfaces together at slightly more than the pressure of the fluid. Cross-port leakage is thought to be caused by scratches or depressions in the surface of the stationary and/or rotary element that form leak grooves. Such leak grooves provide a path for fluid flow when there is a pressure gradient between the ports. Lifetime is increased by delaying the onset, reducing the number, and minimizing the size of such leak grooves.

In valves, the design of surfaces to maximize lifetime is difficult to do from first principles. This is because, as is commonly understood, the subject of wear of component parts is of considerable complexity. It incorporates various scientific and technological disciplines such as surface chemistry, fluid mechanics, materials, lubricants, contact mechanics, bearings, and lubrication systems, and is customarily divided into three branches known as friction, lubrication and wear. An understanding of wear, and its related tribological (study of friction and wear) topics of friction and lubrication, involves topics such as asperity deformation, adhesion, modes of energy dissipation, molecular relaxation times, etc. Each topic in itself is a complex subject.

The limitations of the science of tribophysics cause the development of longlife valves of the type being discussed to be driven by experimentation using a large variety of materials and surface treatments that would not necessarily be expected to produce good results. Indeed, little is predictable in the art of making valves.

For example, ceramic is an extremely wear resistant material that has been used as a counterface against polymeric rotary elements. However, the polymers that exhibit long lifetime against ceramic must be determined experimentally. Furthermore, when certain polymers are used as rotors and run against polished ceramic, the presence in the ceramic of relatively large pits does not necessarily cause excessive wear and short lifetime. Conversely, some extremely smooth ceramic surfaces cause high wear.

Even when ceramic is used as a counterface against another ceramic rotary element, wear and friction issues persist. The interfacing surfaces may be factory lubricated to improve sealing, reduce friction, and minimize contamination buildup. This factory lubrication, however, is short lived but delays the onset of wear, abrasion, scoring, and contamination. Additionally, in the case of ceramic valves, the very flat surfaces subject the valve faces to molecular adhesion, which causes high drag forces and even stalling during motion cycles.

### SUMMARY OF THE INVENTION

It is an object of the present invention to provide an apparatus that materially reduces the molecular adhesion of the mating, flat, interfacing surfaces of a shear valve to one another. It is another object of the present invention to provide a device that minimizes the adherence of contaminants to the interfacing surfaces. It is further object of the present invention to provide a device with a predictable fluidic seal between the mating surfaces. It is still another object of the present invention to reduce the coefficient of friction between the mating surfaces for the life of the device. It is yet a further object of the present invention to reduce the wear at the interface between the moving and stationary members of a shear valve to sustain the sealing conditions of the interfacing surfaces.

The present invention achieves these and other objectives by providing a shear valve with surface modification achieved through the application of a diamond-like coating, and/or continuous lubrication using a method for continually supplying lubrication to the interfacing surfaces.

In one embodiment of the present invention, the shear valve assembly includes a stationary valve manifold having a manifold planar surface, a movable valve switch having a switch planar surface in slidable, interactive contact with the manifold planar surface forming an interactive contact junction, a surface modifying component disposed at the interactive contact junction, a drive shaft fixedly connected to the movable valve switch, an index sensor operatively coupled to one of the drive shaft and the movable valve switch, a biasing mechanism coupling the manifold planar surface of the stationary valve manifold to the switch planar surface of the movable valve switch, and a valve housing supporting the stationary valve manifold, the movable valve switch, the drive shaft and the index sensor. The stationary valve manifold contains a plurality of manifold input ports and one or more manifold output ports. The switch planar surface of the movable valve switch has a fluid switching channel capable of connecting one of the plurality of manifold input ports with one of the one or more manifold output ports. The surface modifying component provides a period of extended useful life of the manifold planar surface and the switch planar surface beyond the useful life of a pre-lubricated interactive contact junction even when ceramic components are used. The surface modifying component also reduces molecular adhesion by using very flat shear surfaces.

In another embodiment of the present invention, the surface modifying component is a diamond-like coating disposed on the manifold planar surface, the movable switch planar surface, or both. The diamond-like coating may be disposed over a major portion of the planar surface or over all of the planar surface. The diamond-like coating provides a very low coefficient of friction characterized by a molecular material arrangement that counteracts the surface adhesion phenomena, creates a very hard, wear resistant surface, and a low propensity to adhere to contaminants.

In another embodiment of the present invention, the surface modifying component is an excess lubricant storing mechanism. The excess lubricant storing mechanism is configured to hold several times more lubricant than is typically provided in pre-lubricated shear valves.

In a further embodiment of the present invention, the excess lubricant storing mechanism is a lubricant pocket formed within one of the manifold planar surface or the switching planar surface. The lubricant pocket is capable of containing several times more lubricant than is customarily provided in pre-lubricated shear valves.

In still another embodiment of the present invention, the excess lubricant pocket contains a lubricant wiping pad to insure a constant wiping and lubrication of the interactive junction.

In yet another embodiment of the present invention, the excess lubricant storing mechanism is a lubricant reservoir located outside of the valve housing. The lubricant reservoir is connected to the stationary valve manifold through a lubricant supply tube. The lubricant supply tube connects to a manifold lubricant tube, which is in communication with a lubricant supply port formed in the manifold planar surface. The lubricant reservoir insures a constant supply of lubricant to the interactive junction.

In a further embodiment of the present invention, the shear valve is one of a rotary valve or a linear valve. It is important to note that the diamond-like coating may also be used in conjunction with the lubricating methods described above.

### BRIEF DESCRIPTION OF THE DRAWINGS

FIG. 1 is a perspective view of one embodiment of the present invention showing a rotary valve with a view port cut in to show the ceramic components.

FIG. 2 is a cross-sectional view of the present invention in FIG. 1 showing the internal components of the rotary valve.

FIG. 3 is a perspective view of one embodiment of the present invention showing a ceramic manifold with a diamond-like coating on a mating surface.

FIG. 4 is a perspective view of one embodiment of the present invention showing a ceramic rotor with a diamond-like coating on a mating surface.

FIG. 5 is a perspective view of another embodiment of the present invention showing the ceramic manifold without a coating on the mating surface.

FIG. 6 is a perspective view of another embodiment of the present invention showing the ceramic rotor with a recess or pocket formed into the mating surface.

FIG. 7 is a perspective view of the embodiment in FIG. 6 showing the ceramic rotor with the recess/pocket containing an oiling pad.

FIG. 8 is a perspective view of another embodiment of the present invention showing a rotary valve incorporating an external lubricator.

FIG. 9 is a perspective view of the ceramic manifold assembly used in FIG. 8 showing the tube side of the ceramic manifold with an external lubricating tube.

FIG. 10 is a perspective view of the embodiment in FIG. 9 showing the mating side of the ceramic manifold with the external lubricating tube.

FIG. 11 is a perspective view of one embodiment of the present invention showing the ceramic rotor with a lubricant groove in the mating surface.

FIG. 12 is a perspective view of another embodiment of the present invention showing a linear shear valve.

FIG. 13 is a perspective view of the embodiment in FIG. 12 showing the mating surface of the stationary valve manifold.

FIG. 14 is a perspective view of the embodiment in FIG. 12 showing the mating surface of the movable valve switch.

FIG. 15 is a front view of the embodiment in FIG. 12 showing one position of the linear shear valve and the connected inlet and outlet ports of the stationary valve manifold with the movable valve switch.

### DETAILED DESCRIPTION OF THE PREFERRED EMBODIMENT

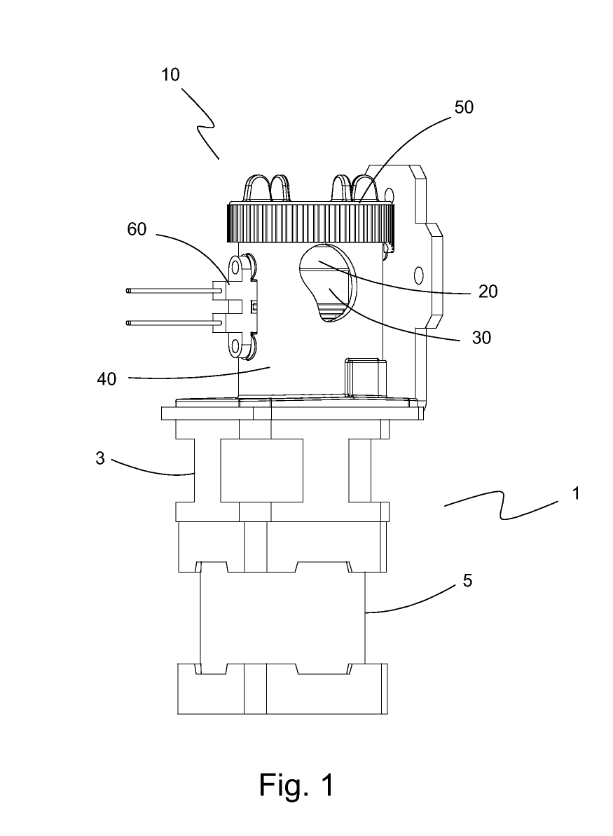

The preferred embodiment(s) of the present invention are illustrated in FIGS. 1-15. FIG. 1 Illustrates one embodiment of the rotary valve assembly 10 of the present invention assembled and connected to a drive source 1 that includes a gear box 3 and a motor 5. A section of rotary valve assembly 10 is removed to allow viewing of some of the internal components. Rotary valve assembly 10 includes a stationary valve manifold 20 and a movable valve rotor assembly 30 encased within a valve housing 40 by a retainer 50. Rotary valve assembly 10 also includes an index sensor 60 that detects a home index position of valve rotor assembly 30. Gear box 3 is used in combination with motor 5 to provide motion to valve rotor assembly 30.

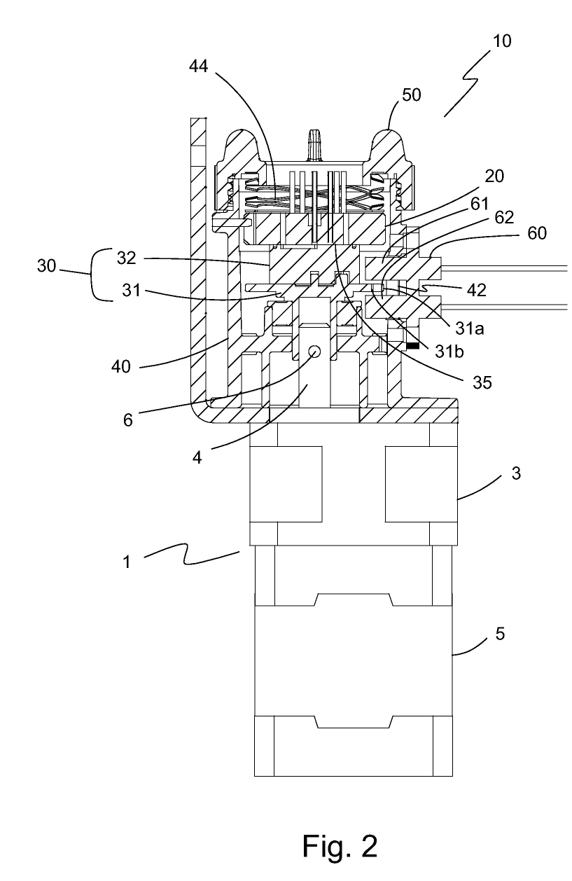

Turning now to FIG. 2, there is illustrated a cross-sectional view of the embodiment of rotary valve assembly 10 shown in FIG. 1. Valve rotor assembly 30 includes a drive shaft 31 and a valve rotor 32 fixedly connected to the drive shaft 31. Valve rotor 32 contacts stationary valve manifold 20 at an interface junction 35. A biasing mechanism 44 such as, for example, a load spring provides a force suitable for maintaining intimate contact between stationary valve manifold 20 and valve rotor 32 at interface junction 35. Stationary valve manifold 20 and movable valve rotor 32 are typically made of ceramic, metal or plastic such as a fluorocarbon-based material.

It is interface junction 35 that provides the sealing and selection of various input outlets. Drive shaft 31 is fixedly connected to an output shaft 4 of gearbox 3. Retainer 50 is removably connected to valve housing 40 and is the access point to the inside of valve housing 40 for maintaining and servicing of stationary valve manifold 20 and movable valve rotor assembly 30. Retainer 50 in conjunction with biasing mechanism 44 applies the load force to stationary valve manifold 20 and movable valve rotor assembly 30. Retainer 50 may be a cap, a plug, a split ring, and the like, which are typically used for retaining one component within a housing. It will be recognized by those skilled in the art that other driving configurations and structural housing mechanisms can achieve the same result without detracting from the intent of the present invention. Home index sensor 60 in this embodiment extends through a valve housing window 42 where a pair of index sensor elements 61, 62 have a spaced arrangement from each other with a peripheral extension 31a of drive shaft 31 is disposed in the space between the pair of index sensor elements 61, 62. The peripheral extension 31a has a notch or aperture 31b that serves as the valve rotor index. It should be understood that the valve rotor 32 may contain the valve rotor index instead of drive shaft 31.

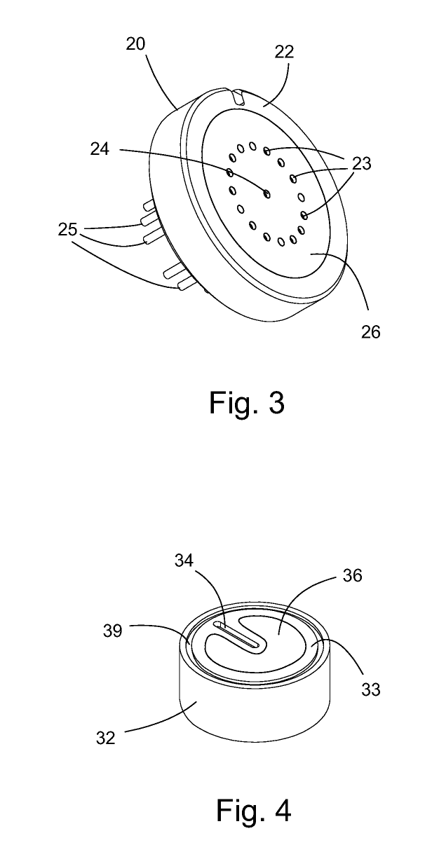

FIG. 3 illustrates a perspective view of stationary valve manifold 20. Valve manifold 20 has a manifold planar surface 22 containing a plurality of manifold input ports 23, and a manifold output port 24. Extending from each of the plurality of manifold input ports 23 and manifold output port 24 are a plurality of manifold port tubes 25. In the alternative, the plurality of manifold input ports 23 may be the manifold output ports and manifold output port 24 may be an manifold input port. Disposed on manifold planar surface 22 is a diamond-like material forming a diamond-like coating 26 over all or over a major portion of manifold planar surface 22. The diamond-like material has certain advantageous characteristics when used as a coating on a surface. These include (1) a low coefficient of friction when a surface having the coating is moved against another surface having the same coating or a surface made of other materials, (2) almost no generation of Van der Waals forces between the opposed coated surfaces, (3) an extremely hard surface to diminish wear over a very large number of cycles, and (4) low adhesion to contaminants within the switched fluids. An example of an acceptable diamond-like coating is sold under the trademark Diamonex®.

FIG. 4 is a perspective view of valve rotor 32. Valve rotor 32 has a rotor planar surface 33 and a fluid switching channel 34 formed within rotor planar surface 33. Fluid switching channel 34 is positioned within rotor planar surface 33 to selectively connect one of the manifold input ports 23 with manifold output port 24 formed in manifold planar surface 22 of stationary valve manifold 20. In this embodiment, rotor planar surface 33 also has a diamond-like coating 36 disposed over all or over a major portion of rotor planar surface 22. Rotor planar surface 33 may optionally include a lubricant groove 39 for containing excess lubricant when a lubricant is pre-installed in valve assembly 10 when providing a pre-lubricated interface junction 35.

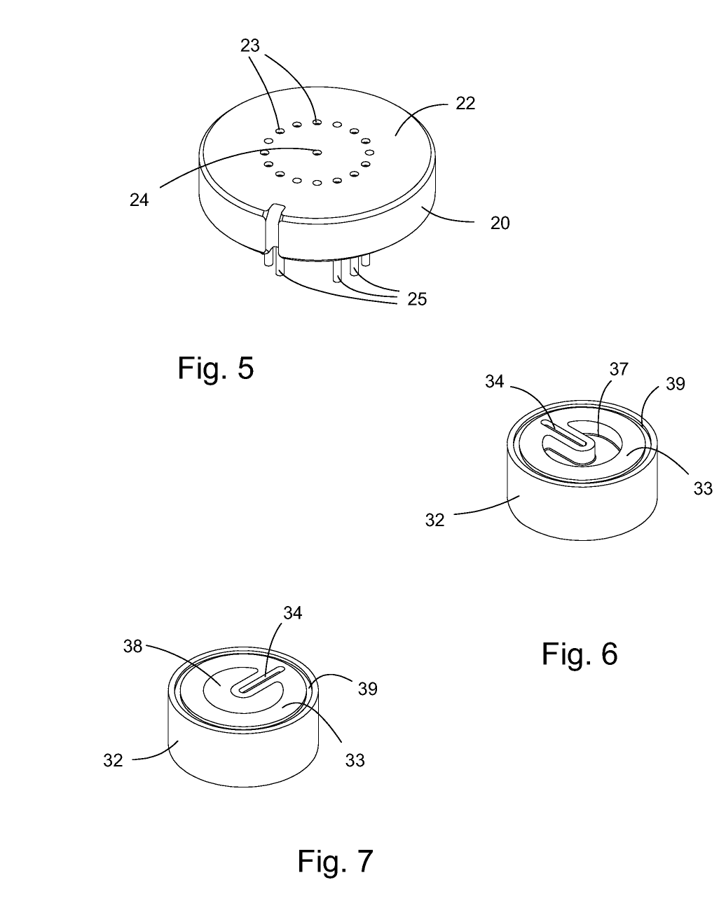

FIG. 5 is a perspective view of another embodiment of stationary valve manifold 20. In this embodiment, stationary valve manifold 20 has a manifold planar surface 22, a plurality of manifold input ports 23 and a manifold output port 24. Extending from each of the plurality of manifold input ports 23 and manifold output port 24 are a plurality of manifold port tubes 25. This embodiment of stationary valve manifold 20 has no diamond-like coating disposed on manifold planar surface 22.

FIG. 6 is a perspective view of another embodiment of valve rotor 32 for use with stationary valve manifold 20 in FIG. 5. Valve rotor 32 has a rotor planar surface 33 and a fluid switching channel 34 formed within rotor planar surface 33. Fluid switching channel 34 is positioned within rotor planar surface 33 to selectively connect one of the manifold input ports 23 with manifold output port 24 formed in manifold planar surface 22 of stationary valve manifold 20. In this embodiment, rotor planar surface 33 also has a lubricant storage pocket 37 formed within a portion of rotor planar surface 33. Lubricant storage pocket 37 has a volume several times larger than lubricant groove 39 to enable continuous, long term use of rotary valve assembly 10 and extending the useful life of rotary valve assembly 10 between maintenance and servicing of rotary valve assembly 10. FIG. 7 is a perspective view of FIG. 6 that further includes an optional lubricant wiping pad 38 disposed within lubricant storage pocket 37. Lubricant wiping pad 38 provides a constant wiping of the interface junction 35 with lubricant. Use of lubricant wiping pad 38 enhances the storage and dispensing of the lubricant. A preferred material for use as lubricant wiping pad 38 is felted reticulated foam. It has been found that constant application of the lubricant to the interface junction 35 greatly retards wear, buildup and adhesion of contaminants, and reduces friction.

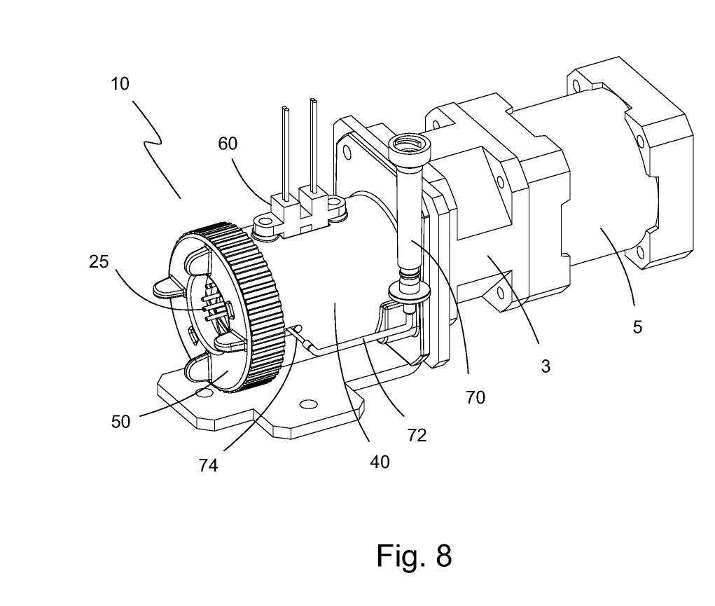

Turning now to FIG. 8, there is illustrated another embodiment of the present invention. Like previous embodiments of rotary valve assembly 10, this embodiment includes a stationary manifold 20 (not shown) and a movable rotor assembly 30 (not shown) encased within a valve housing 40 by a retainer 50. Rotary valve assembly 10 also includes an index sensor 60 that detects a home index position of movable rotor assembly 30. Gear box 3 is used in combination with motor 5 to provide motion to movable rotor assembly 30. To achieve increased useful life of rotary valve assembly 10, constant lubrication of the interface junction 35 (not shown) is provided by a lubricant reservoir 70 located outside of valve housing 40. Lubricant reservoir 70 includes a lubricant supply tube 72 that connects to a manifold lubricant inlet tube 74 to provide constant lubrication to the interface junction 35 of rotary valve assembly 10. As the name implies, lubricant reservoir 70 stores and supplies the lubricant to the interface junction 35.

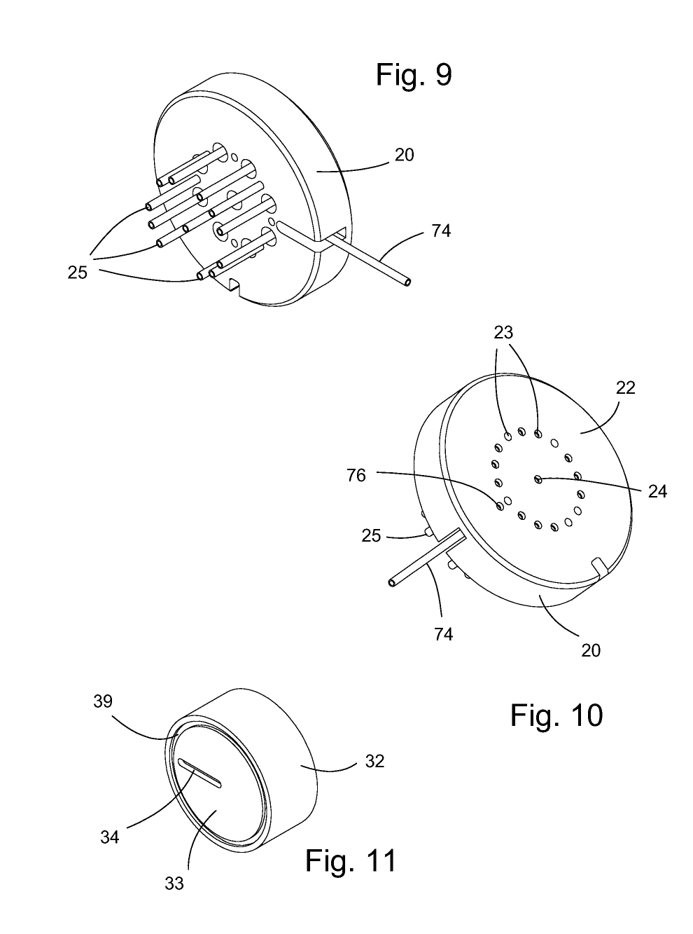

FIG. 9 illustrates a back perspective view of the stationary valve manifold 20 for use with lubricant reservoir 70. In addition to the inlet port and outlet port tubes 25, stationary valve manifold 20 includes a lubricant inlet tube 74 that provides fluid communication between lubricant reservoir 70 and the interface junction 35 between manifold planar surface 22 and switching planar surface 33. FIG. 10 is a front perspective view of stationary valve manifold 20 in FIG. 9. As illustrated, lubricant inlet tube 74 connects to manifold planar surface 22 by way of lubricant supply port 76. In this embodiment, lubricant supply port 76 is preferably located in manifold planar surface 22 at a greater radial distance from the center of stationary valve manifold 20 than inlet ports 23 and outlet port 24. This location aligns lubricant supply port 76 with lubricant groove 39 in rotor planar surface 33 of valve rotor 32 shown in FIG. 11. Lubricant reservoir 70 continually replenishes the lubricant, which retards wear, reduces buildup and adhesion of contaminants, and reduces friction.

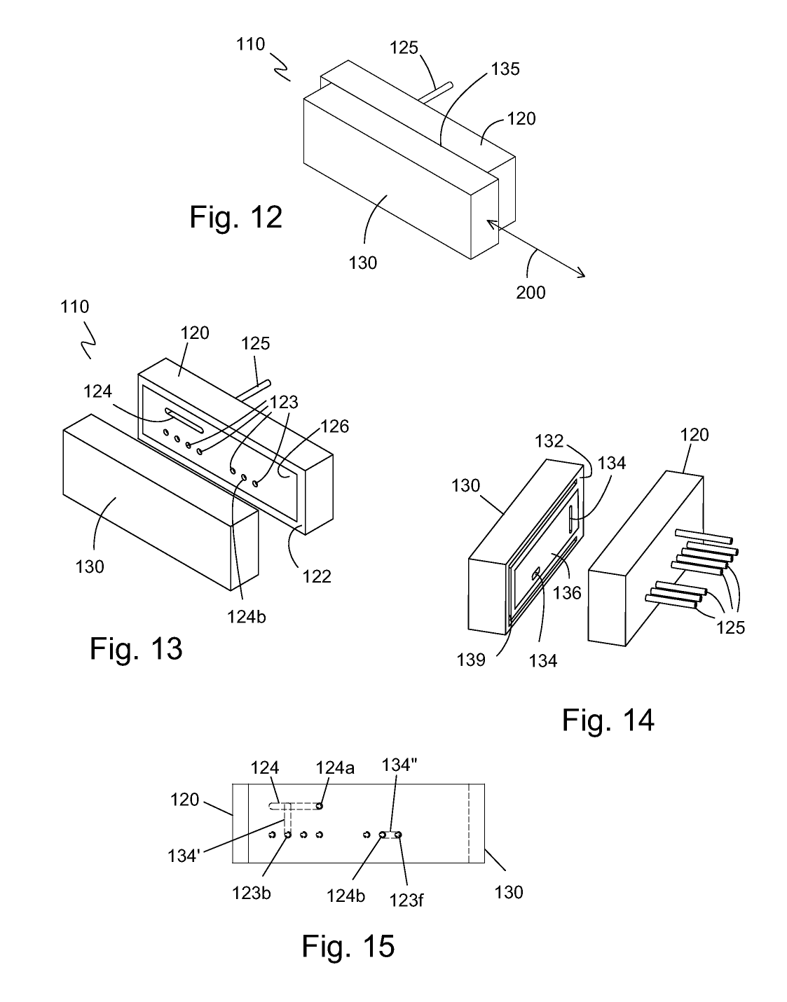

Turning now to FIG. 12, there is illustrated a linear shear valve 110. Linear shear valve 110 includes a stationary valve manifold 120 and a movable valve switch 130 in a slidable arrangement relative to each other at interface junction 135. Arrow 200 indicates the linearly slidable movement of movable valve switch 130 relative to stationary valve manifold 120.

FIG. 13 illustrates a perspective view of stationary valve manifold 120. Valve manifold 120 has a manifold planar surface 122 containing a plurality of manifold input ports 123, a manifold output port channel 124, and a manifold output port 124a (not shown). Extending from each of the plurality of manifold input ports 123 and manifold output port 124a are a plurality of manifold port tubes 125, only one of which can be seen in this Figure. In the alternative, the plurality of manifold input ports 123 may be the manifold output ports and manifold output port 124a may be an manifold input port. Disposed on manifold planar surface 122 is a diamond-like material forming a diamond-like coating 126 over all or over a major portion of manifold planar surface 122. As previously described, the diamond-like material has certain advantageous characteristics when used as a coating on a surface.

FIG. 14 is a perspective view of movable valve switch 130. Valve switch 130 has a valve switch planar surface 132 and a fluid switching channel 134 formed within switch planar surface 132. Fluid switching channel 134 is positioned within switch planar surface 132 to selectively connect one of the manifold input ports 123 with manifold output port 124a through manifold output port channel 124 formed in manifold planar surface 122 of stationary valve manifold 120. In this embodiment, switch planar surface 132 also has a diamond-like coating 136 disposed over all or over a major portion of switch planar surface 122. Switch planar surface 132 may optionally include a lubricant groove 139 for containing excess lubricant when a lubricant is pre-installed in valve assembly 110 when providing a pre-lubricated interface junction 135. It is important to note that linear shear valve 110 may optionally include a plurality of input and output selection ports as illustrated by the two fluid switching channels 134. As best seen in FIG. 14, stationary valve manifold 120 has a plurality of manifold port tubes 125.

FIG. 15 is a front view of linear shear valve 110 showing one example and position of a selected port. Fluid switching channels 134 and manifold output port channel 124 are shown as dashed lines. As can be seen, fluid switching channel 134′ overlaps with manifold output port channel 124 to fluidly communicate inlet port 123b with output port 124a and fluid switching channel 134″ overlaps two other manifold ports to fluidly communicate inlet port 123f with output port 124b. Any number of drive mechanisms may be used to slidably move valve switch 130 relative to stationary valve manifold 120 at the interface junction 135, all as is well known by those of ordinary skill in the art.

It is understood that linear shear valve 110 may include the optional features disclosed for rotary shear valve 10. These include the lubricant groove in the switch planar surface 132, the lubricant pocket in the switch planar surface 132, the lubricant wiping pad disposed within the lubricant pocket, and the lubricant reservoir that can be either internal or external to the valve housing and connected to the lubricant groove by way of a manifold lubricant port.

As described above, the present invention provides surface modification of the opposing planar surfaces of a shear valve by the application of a diamond-like coating in one embodiment and/or continuous lubrication by continually supplying lubrication to the interface junction 35, 135 of the shear valve assembly 10, 110, respectively. It should also be noted that the features of continuous lubrication can be combined with the use of a diamond-like coating to further extend the serviceable life of a shear valve assembly.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A rotary valve assembly comprising:
a stationary valve manifold having a manifold planar surface containing a plurality of manifold input ports and one or more manifold output ports;
a valve rotor having a rotor planar surface in slidable, interactive contact with the manifold planar surface forming an interactive contact junction, the rotor planar surface having a radial fluid switching channel capable of connecting one of the plurality of manifold input ports with one of the one or more manifold output ports;
a surface modifying component disposed at the interactive contact junction that provides a period of extended useful life of the manifold planar surface and the rotor planar surface beyond the useful life of pre-lubricated interactive contact junction;
a drive shaft connected to the valve rotor; and
a valve housing supporting the stationary valve manifold, the valve rotor, and the drive shaft.

2. The rotary valve assembly of claim 1 wherein the surface modifying component is selected from the group consisting of an excess lubricant storage mechanism and a diamond-like coating disposed on at least one of the manifold planar surface and the rotor planar surface.

3. The rotary valve assembly of claim 2 wherein the diamond-like coating is disposed on the manifold planar surface and the rotor planar surface.

4. The rotary valve assembly of claim 2 wherein the excess lubricant storage mechanism is a lubricant pocket situated within one of the manifold planar surface and the rotor planar surface.

5. The rotary valve assembly of claim 4 further comprising a lubricant pad disposed within the lubricant pocket.

6. The rotary valve assembly of claim 2 wherein the excess lubricant storage mechanism is a lubricant supply tube in communication on one end with a lubricant supply port disposed in the manifold planar surface and on an opposite end with a lubricant reservoir.

7. The rotary valve assembly of claim 1 further comprising a retainer connected to the valve housing and structured to retain the stationary valve manifold in slidable, interactive contact with the movable valve rotor within the valve housing.

8. The rotary valve assembly of claim 7 wherein the retainer is one of a cap, a plug or a split ring.

9. The rotary valve assembly of claim 1 further comprising an index sensor operatively coupled to one of the drive shaft and the valve rotor.

10. A method of reducing friction and wear in a multiport valve assembly, the method comprising:
forming a stationary valve manifold having a manifold planar surface containing a plurality of manifold input ports and one or more manifold output ports;
forming a movable valve switch having a switch planar surface in slidable, interactive contact with the manifold planar surface forming an interactive contact junction, the switch planar surface having a radial fluid switching channel capable of connecting one of the plurality of manifold input ports with one of the one or more manifold output ports;
incorporating a surface modifying component at the interactive contact junction that provides a period of extended useful life of the manifold planar surface and the rotor planar surface beyond the useful life of a pre-lubricated interactive contact junction;
connecting a drive shaft to the movable valve switch; and
assembling the stationary valve manifold, the movable valve switch, and the drive shaft into a valve housing.

11. The method of claim 10 wherein the step of incorporating a surface modifying component includes disposing a diamond-like coating onto at least one of the manifold planar surface and the switch planar surface.

12. The method of claim 10 wherein the step of incorporating a surface modifying component includes forming an excess lubricant pocket into one of the manifold planar surface and the switch planar surface

13. The method of claim 12 wherein the step of forming an excess lubricant pocket includes disposing a lubricating pad into the excess lubricant pocket.

14. The method of claim 10 wherein the step of incorporating a surface modifying component includes forming a lubricant supply port in the manifold planar surface and attaching one end of a lubricant supply tube to the lubricant supply port and the other end to a lubricant reservoir.

15. A shear valve assembly comprising:
a stationary valve manifold having a manifold planar surface containing a plurality of manifold input ports and one or more manifold output ports;
a movable valve switch having a switch planar surface in slidable, interactive contact with the manifold planar surface forming an interactive contact junction, the switch planar surface having a fluid switching channel capable of connecting one of the plurality of manifold input ports with one of the one or more manifold output ports;
a surface modifying component disposed at the interactive contact junction that provides a period of extended useful life of the manifold planar surface and the switch planar surface beyond the useful life of a pre-lubricated interactive contact junction;
a drive shaft connected to the movable valve switch; and
a valve housing supporting the stationary valve manifold, the movable valve switch, and the drive shaft.

16. The shear valve assembly of claim 15 wherein the surface modifying component is selected from the group consisting of an excess lubricant storage mechanism and a diamond-like coating disposed on at least one of the manifold planar surface and the switch planar surface.

17. The shear valve assembly of claim 16 wherein the diamond-like coating is disposed on the manifold planar surface and the switch planar surface.

18. The shear valve assembly of claim 16 wherein the excess lubricant storage mechanism is a lubricant pocket situated within one of the manifold planar surface and the shear planar surface.

19. The shear valve assembly of claim 18 further comprising a lubricant pad disposed within the lubricant pocket.

20. The shear valve assembly of claim 16 wherein the excess lubricant storage mechanism is a lubricant supply tube in communication on one end with a lubricant supply port disposed in the manifold planar surface and on an opposite end with a lubricant reservoir.

21. The shear valve assembly of claim 15 wherein the shear valve assembly is one of a rotary valve assembly and a linear valve assembly.

22. The shear valve assembly of claim 15 further comprising an index sensor operatively coupled to one of the drive shaft and the movable valve switch.
